(19) United States
(12) Patent Application Publication
(10) Pub. No.: US 2018/0332674 A1
(43) Pub. Date: Nov. 15, 2018

(54) MICROWAVE OVEN CIRCUIT, CONTROL METHOD AND CONTROL DEVICE OF MICROWAVE OVEN CIRCUIT AND MICROWAVE OVEN

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Yueyue LIN, Foshan (CN); Xiaojin ZHOU, Foshan (CN)

(21) Appl. No.: 16/021,167

(22) Filed: Jun. 28, 2018

Related U.S. Application Data
(63) Continuation of application No. PCT/CN2016/087159, filed on Jun. 24, 2016.

(30) Foreign Application Priority Data
Dec. 29, 2015 (CN) 201511027305.2
Dec. 29, 2015 (CN) 201511030511.9
Dec. 29, 2015 (CN) 201521139218.1

(51) Int. Cl. H05B 6/68; H05B 6/64

(52) U.S. Cl. CPC H05B 6/681; H05B 2206/04; H05B 6/6447; H05B 6/687

(57) ABSTRACT

The present disclosure provides a microwave oven circuit, a control method and a control device of the microwave oven circuit, and a microwave oven. The microwave oven circuit includes a magnetron and an inverter circuit for driving the magnetron to work. The control method includes when the inverter circuit needs to be started, detecting a zero crossing point of an electric supply signal for supplying power to the microwave oven circuit, when the electric supply signal is detected to reach the zero crossing point, controlling the inverter circuit to be powered on; when the power-on time length of the inverter circuit reaches a first predetermined time length.

### CROSS-REFERENCES TO RELATED APPLICATIONS

The present application claims the priority of the following patent applications, the entire contents of which are herein incorporated by reference: Chinese Application No. 201511027305.2, filed in the Chinese Patent Office on Dec. 29, 2015, and entitled “CONTROL METHOD AND CONTROL DEVICE OF MICROWAVE OVEN CIRCUIT AND MICROWAVE OVEN”; Chinese Application No. 201521139218.1, filed in the Chinese Patent Office on Dec. 29, 2015, and entitled “MICROWAVE OVEN CIRCUIT AND MICROWAVE OVEN”; and Chinese Application No. 201511030511.9, filed in the Chinese Patent Office on Dec. 29, 2015, and entitled “MICROWAVE OVEN CIRCUIT AND MICROWAVE OVEN”.

### FIELD OF THE INVENTION

The present disclosure relates to the technical field of microwave ovens, and in particular to a microwave oven circuit, a control method of the microwave oven circuit, a control device of the microwave oven circuit control device and a microwave oven.

### BACKGROUND OF THE INVENTION

An inverter in a microwave oven circuit has the advantages of light weight, high power factor, continuously adjustable power and the like relative to a transformer power supply, and thus has been widely favored by users. With the extensive use of inverters, the repair rate in the market has been generally increased, and it can be seen from repair data that IGBTs (Insulated Gate Bipolar Transistors) and rectifier bridge stacks account for the most of the damage. The control mode at present has received severe challenges.

As shown in FIG. 1, an existing variable frequency microwave oven control system includes an electric control board and a high frequency heating device. The electronic control board includes an MCU, a relay driving device and a PWM (Pulse Width Modulation) driving device, the relay driving device transmits an electric power signal to an inverter in the high frequency heating device, and the PWM driving circuit transmits a power signal to the inverter in the high frequency heating device, and the inverter drives a magnetron to generate microwaves according to the received signal so as to achieve the purpose of heating food.

As shown in FIG. 2, which is a structural schematic diagram of the inverter in the existing microwave oven circuit, the working principle of the inverter is as follows: after being rectified by a rectifier bridge stack 1′, electric supply flows through a filter circuit 2′ consisting of an inductor L1′ and a capacitor C1′ and then is led to a resonant network consisting of a resonant capacitor 3′ and a high frequency step-up transformer 4′, and the resonant energy is controlled by the on-off of an IGBT 5′ to be fed back to a secondary stage of the high frequency step-up transformer 4′, a high voltage for driving the magnetron is generated through a voltage doubling circuit 6′ consisting of high voltage capacitors C2′, C3′ and high voltage diodes D1′, D2′, and then is transmitted to the magnetron so as to drive the magnetron to generate microwaves.

The magnitude of the resonant current can be changed by changing the switching frequency of the IGBT 5′ so as to change the power of the magnetron.

As shown in FIG. 3, in control timing proposed by the related art, when a microwave relay is started, it provides an electric power signal for the inverter and meanwhile transmits a target power signal PWM to the inverter to reach the desired power. However, when the microwave relay is turned on, if the voltage across the capacitor C2′ in the inverter is not zero, if the voltage of the electric supply is higher at the moment, a higher abnormal voltage is generated across the rectifier bridge stack 1′ at the peak value, which is up to more than 1,000 volts and is very likely to damage the bridge stack.

FIG. 4 shows a voltage waveform of the electric supply signal when the inverter is turned on, a control signal waveform of the microwave relay, and a voltage waveform (i.e., a Vab waveform) across the rectifier bridge stack 1′ in the related art. Assuming that the electric supply is 220V AC, if the electric supply signal is at the peak value 310V, and the voltage across the capacitor C2′ is 0 when the microwave relay is turned on, at the moment when the microwave relay is turned on, as the voltage across the capacitor C2′ may not be changed abruptly, the peak value 310V of the electric supply is directly added to the inductor L1′, and due to the characteristic of the inductor (i.e., the current may not be abruptly changed), a very large reverse voltage is generated to prevent the current from increasing, in this way, a very large voltage is generated at the front end, namely, the port of the rectifier bridge stack 1′, which is up to 1000V and is very likely to damage the rectifier bridge stack P. The theoretical analysis is also consistent with the market feedback data, that is, the maintenance rate of the rectifier bridge stack 1′ remains high.

Meanwhile, another component having a high maintenance rate is the IGBT 5′, because the G pole voltage of the IGBT may not exceed 25V, but in the existing control mode, when the microwave relay is turned on, the G pole of the IGBT occasionally has a voltage of higher than 33V.

Therefore, how to reduce the voltage across the rectifier bridge stack when the inverter is turned on to avoid damage to the rectifier bridge stack due to the excessively high voltage across the rectifier bridge stack, and meanwhile how to prevent the G pole of the IGBT from being damaged by the overlarge voltage have become technical problems to be solved urgently.

### BRIEF SUMMARY OF THE INVENTION

The present disclosure aims at solving at least one of the technical problems existing in the prior art or related art.

The present disclosure is to provide a new microwave oven circuit that can reduce the voltage across a rectifier bridge stack when an inverter is turned on to avoid damage to the rectifier bridge stack due to the excessively high voltage across the rectifier bridge stack, and meanwhile can avoid a G pole of an IGBT from being damaged by the overlarge voltage.

The present disclosure is to provide a control method and a control device of a microwave oven circuit, and a microwave oven.

According to an embodiment of the present disclosure, a microwave oven circuit is provided, including: an electric control board and a high frequency heating circuit, and the electric control board includes: a relay driving circuit configured to transmit an electric power signal to the high frequency heating circuit; a power driving circuit configured to send a power signal to the high frequency heating circuit; a first filter circuit connected to a signal feedback end of the high frequency heating circuit and configured to perform filtering processing on a magnetron current signal fed back by the high frequency heating circuit; an analog to digital conversion circuit connected to the first filter circuit and configured to perform analog to digital conversion processing on the signal output by the first filter circuit; and a controller connected to the analog to digital conversion circuit, the relay driving circuit and the power driving circuit and configured to control the electric power signal transmitted by the relay driving circuit and controlling the power signal transmitted by the power driving circuit according to the signal output by the analog to digital conversion circuit.

According to the microwave oven circuit of the embodiment of the present disclosure, by performing the filtering processing on the magnetron current signal fed back by the high frequency heating circuit, performing the analog to digital conversion processing through the analog to digital conversion circuit and controlling by the controller the power signal transmitted by the power driving circuit according to the signal output by the analog to digital conversion circuit, the problem of power overshoot during the startup of an inverter circuit can be avoided, meanwhile an interference signal can be reduced as much as possible when the inverter circuit is turned on, for example, the voltage of the G pole of the IGBT and a reverse voltage across the rectifier bridge stack when the inverter circuit is turned on, in this way, the rectifier bridge stack is prevented from being damaged by the excessively high voltage across the rectifier bridge stack, and meanwhile, the G pole of the IGBT is prevented from being damaged by the overlarge voltage.

In one embodiment, the control process of the controller in the electric control board is as follows:

When an instruction of starting the microwave oven is received, if it is detected that an electric supply signal reaches a zero crossing point, a fan circuit and a turntable circuit in the microwave oven circuit are controlled to be turned on, and after the fan circuit and the turntable circuit are controlled to be turned on for a certain time length, when the electric supply signal is detected to reach the zero crossing point, the inverter circuit is controlled to be powered on. After the inverter circuit is powered on, a power signal with a frequency lower than a target frequency is input to the inverter circuit after a period of delay time; and when the current in a magnetron reaches a predetermined current value, if it is detected that the electric supply signal for supplying power to the microwave oven circuit reaches the zero crossing point, a power signal with a frequency equal to the target frequency is input to the inverter circuit.

In the above control process, both a fan and a turntable are inductive loads, so electromagnetic radiation and voltage interference are generated when they are turned on, thus affecting the voltage of the G pole of the IGBT, therefore, when the instruction of starting the microwave oven is received, and when the electric supply signal is detected to reach the zero crossing point, the fan circuit and the turntable circuit are controlled to be turned on, and after a certain time length, when the electric supply signal is detected to reach the zero crossing point, the inverter circuit is controlled to be powered on (i.e., it is determined that the inverter circuit needs to be started), in this way, when the fan circuit and the turntable circuit are turned on, the interference to the voltage of the G pole of the IGBT can be effectively reduced so as to prevent the G pole of the IGBT from being damaged by the overlarge voltage and to prolong the service life of the IGBT.

By controlling the inverter circuit to be powered on when the electric supply signal is detected to reach the zero crossing point, the reverse voltage across the rectifier bridge stack can be effectively reduced when the inverter circuit is powered on, thereby improving the reliability of the microwave oven circuit and prolonging the service life of the rectifier bridge stack.

After the inverter circuit is powered on, the power signal is not directly input to the inverter circuit, but is input after a period of delay time, so that power-on initialization time can be reserved for electronic devices in the inverter circuit to ensure the working stability of the inverter circuit.

By firstly inputting the power signal with the frequency lower than the target frequency to the inverter circuit, and inputting the power signal with the frequency equal to the target frequency to the inverter circuit when it is detected that the current in the magnetron reaches the predetermined current value (the predetermined current value indicates that the magnetron starts working), the inverter circuit can be started at a smaller power, and when the magnetron starts working, the inverter circuit operates with full power (i.e., the power signal with the target frequency is input), thereby avoiding the problem of power overshoot during the startup of the inverter circuit.

The microwave oven circuit according to the above embodiment of the present disclosure can further have the following technical features:

According to one embodiment of the present disclosure, the high frequency heating circuit includes a magnetron configured to generate microwaves, an inverter circuit connected to the magnetron and configured to receive the electric power signal transmitted by the relay driving circuit and the power signal transmitted by the power driving circuit, and driving the magnetron to generate the microwaves according to the electric power signal and the power signal; and a sampling feedback circuit configured to sample the current in the magnetron and feeding back a sampled magnetron current signal to the electric control board.

According to one embodiment of the present disclosure, the inverter circuit includes: a rectifier circuit connected to an AC power supply and configured to rectify AC input by the AC power supply; a second filter circuit connected to the rectifier circuit and configured to perform filtering processing on a signal output by the rectifier circuit; a resonant circuit including a resonant capacitor and a high frequency step-up transformer, and the resonant capacitor is connected to two ends of the second filter circuit in parallel after being connected with an IGBT in series, and a primary coil of the high frequency step-up transformer is connected with the resonant capacitor in parallel; and a voltage doubling circuit connected to a secondary coil of the high frequency step-up transformer and configured to generate a voltage for driving the magnetron.

According to one embodiment of the present disclosure, the rectifier circuit includes a rectifier bridge circuit.

According to one embodiment of the present disclosure, the second filter circuit includes an LC filter circuit.

According to one embodiment of the present disclosure, the first filter circuit includes: a first resistor, and a first end of the first resistor serves as an input end of the first filter circuit; a second resistor connected between a second end of the first resistor and the ground; a first clamp device connected with the second resistor in parallel; a second clamp device connected between the second end of the first resistor and a DC power supply; an electrolytic capacitor connected with the second resistor in parallel; a current limiting device, and a first end of the current limiting device is connected to the second end of the first resistor, and a second end of the current limiting device serves as an output end of the first filter circuit; and a capacitive element connected between the second end of the current limiting device and the ground.

According to the microwave oven circuit of the embodiment of the present disclosure, after the magnetron current signal is input to the first filter circuit, the voltage is divided by the first resistor and the second resistor and is clamped by the first clamp device and the second clamp device, so that the voltage is not higher than the DC power supply (VCC), nor lower than the GND (ground), and meanwhile, the filtering processing can be performed by the electrolytic capacitor and the capacitive element to convert the high frequency current signal into a low frequency DC signal. By connecting the capacitive element between the second end of the current limiting device and the ground, i.e., connecting the capacitive element to a position close to the output end of the first filter circuit, a better filtering effect can be achieved.

According to one embodiment of the present disclosure, the first clamp device includes a first diode, a cathode of the first diode is connected to the second end of the first resistor, and an anode of the first diode is grounded.

According to one embodiment of the present disclosure, the second clamp device includes a second diode, an anode of the second diode is connected to the second end of the first resistor, and a cathode of the second diode is connected to the DC power supply.

According to one embodiment of the present disclosure, the current limiting device includes a resistive element.

According to an embodiment of the present disclosure, a control method of a microwave oven circuit is provided. The microwave oven circuit includes a magnetron and an inverter circuit for driving the magnetron to work. The control method includes: when the inverter circuit needs to be started, detecting a zero crossing point of an electric supply signal for supplying power to the microwave oven circuit; when the electric supply signal is detected to reach the zero crossing point, controlling the inverter circuit to be powered on; when the power-on time length of the inverter circuit reaches a first predetermined time length, inputting a first power signal with a frequency lower than a target frequency to the inverter circuit; detecting the current in the magnetron; and when the current in the magnetron reaches a predetermined current value, inputting a second power signal with a frequency equal to the target frequency to the inverter circuit.

According to the control method of the microwave oven circuit of the embodiment of the present disclosure, when the inverter circuit needs to be started, the zero crossing point of the electric supply signal is detected, and when the electric supply signal is detected to reach the zero crossing point, the inverter circuit is controlled to be powered on, therefore when the inverter circuit is powered on, a reverse voltage across a rectifier bridge stack can be effectively reduced, thereby improving the reliability of the microwave oven circuit and prolonging the service life of the rectifier bridge stack.

After the inverter circuit is powered on, the power signal is not directly input to the inverter circuit, but is input after delaying the first predetermined time length, so that power-on initialization time can be reserved for electronic devices in the inverter circuit to ensure the working stability of the inverter circuit.

When the power-on time length of the inverter circuit reaches the first predetermined time length, the first power signal with the frequency lower than the target frequency is input to the inverter circuit, and when it is detected the current in the magnetron reaches the predetermined current value (the predetermined current value indicates that the magnetron starts working), the power signal with the frequency equal to the target frequency is input to the inverter circuit, so that the inverter circuit can be started at a smaller power, and when the magnetron starts working, the inverter circuit operates with full power (i.e., the power signal with the target frequency is input), thereby avoiding the problem of power overshoot during the startup of the inverter circuit.

The control method of the microwave oven circuit according to the above embodiment of the present disclosure can further have the following technical features:

According to one embodiment of the present disclosure, the microwave oven circuit further includes a fan circuit and a turntable circuit, and the control method further includes:

when an instruction of starting a microwave oven is received, if the electric supply signal is detected to reach the zero crossing point, controlling the fan circuit and the turntable circuit to be turned on; and when the fan circuit and the turntable circuit are controlled to be turned on for a second predetermined time length, determining that the inverter circuit needs to be started.

According to the control method of the microwave oven circuit of the embodiment of the present disclosure, both a fan and a turntable are inductive loads, so electromagnetic radiation and voltage interference are generated when they are turned on, thus affecting the voltage of the G pole of the IGBT, therefore, when the instruction of starting the microwave oven is received, and when the electric supply signal is detected to reach the zero crossing point, the fan circuit and the turntable circuit are controlled to be turned on, and after delaying the second predetermined time length, the inverter circuit is controlled to be powered on (i.e., it is determined that the inverter circuit needs to be started), in this way, when the fan circuit and the turntable circuit are turned on, the interference to the voltage of the G pole of the IGBT can be effectively reduced so as to prevent the G pole of the IGBT from being damaged by the overlarge voltage and to prolong the service life of the IGBT.

According to one embodiment of the present disclosure, the control method further includes: when an instruction of turning off the microwave oven is received, stopping inputting the power signal to the inverter circuit; and when the time length of stopping inputting the power signal to the inverter circuit reaches a third predetermined time length, if the electric supply signal is detected to reach the zero crossing point, controlling the inverter circuit to be powered off.

According to the control method of the microwave oven circuit of the embodiment of the present disclosure, when the input of the power signal to the inverter circuit is stopped, the inverter circuit undergoes a process in which the power is reduced to zero and a corresponding discharging process. Therefore, when the instruction of turning off the microwave oven is received, the input of the power signal to the inverter circuit is stopped, and after delaying the third predetermined time length, and when the electric supply signal is detected to reach the zero crossing point, the inverter circuit is controlled to be powered off, in this way, it is ensured that after the power of the inverter circuit is reduced to 0 and when the electric supply signal is at the zero crossing point, the inverter circuit is powered off, thus avoiding an abnormal problem generated by directly controlling the inverter circuit to be powered off when the input of the power signal is stopped.

According to one embodiment of the present disclosure, the control method further includes: after the inverter circuit is controlled to be powered off for a fourth predetermined time length, if the electric supply signal is detected to reach the zero crossing point, controlling the fan circuit and the turntable circuit to be powered off.

According to the control method of the microwave oven circuit of the embodiment of the present disclosure, when the inverter circuit is controlled to be powered off for the fourth predetermined time length, and when the electric supply signal is detected to reach the zero crossing point, the fan circuit and the turntable circuit are controlled to be powered off, therefore the interference to the voltage of the G pole of the IGBT can be reduced, when the inductive loads (i.e., the fan and the turntable) are turned off.

According to one embodiment of the present disclosure, the first predetermined time length is greater than or equal to 300 milliseconds; the second predetermined time length is greater than or equal to 200 milliseconds; the third predetermined time length is greater than or equal to 200 milliseconds; and the fourth predetermined time length is greater than or equal to 600 milliseconds.

According to one embodiment of the present disclosure, the frequency of the first power signal is the lowest frequency for maintaining the continuous work of the inverter circuit, or

the frequency of the first power signal is less than or equal to half of the lowest frequency for maintaining the continuous work of the inverter circuit.

According to one embodiment of the present disclosure, the predetermined current value is less than or equal to one-sixth of the current value in the magnetron when the inverter circuit works at the input of the target frequency.

In any one of the above embodiments, the power-on and power-off of the inverter circuit can be controlled by a microwave relay.

According to an embodiment of the present disclosure, a control device of a microwave oven circuit is further provided. The microwave oven circuit includes a magnetron and an inverter circuit for driving the magnetron to work. The control device includes: a zero crossing point detection device configured to, when the inverter circuit needs to be started, detect a zero crossing point of an electric supply signal for supplying power to the microwave oven circuit; a first control device configured to, when the zero crossing point detection device detects that the electric supply signal reaches the zero crossing point, control the inverter circuit to be powered on; a second control device configured to, when the power-on time length of the inverter circuit reaches a first predetermined time length, input a first power signal with a frequency lower than a target frequency to the inverter circuit, and when a current detection device detects that the current in the magnetron reaches a predetermined current value, inputting a second power signal with a frequency equal to the target frequency to the inverter circuit. The current detection device is configured to detect the current in the magnetron.

According to the control device of the microwave oven circuit of the embodiment of the present disclosure, when the inverter circuit needs to be started, the zero crossing point of the electric supply signal is detected, and when the electric supply signal is detected to reach the zero crossing point, the inverter circuit is controlled to be powered on, therefore when the inverter circuit is powered on, a reverse voltage across a rectifier bridge stack can be effectively reduced, thereby improving the reliability of the microwave oven circuit and prolonging the service life of the rectifier bridge stack.

After the inverter circuit is powered on, the power signal is not directly input to the inverter circuit, but is input after delaying the first predetermined time length, so that power-on initialization time can be reserved for electronic devices in the inverter circuit to ensure the working stability of the inverter circuit.

When the power-on time length of the inverter circuit reaches the first predetermined time length, the first power signal with the frequency lower than the target frequency is input to the inverter circuit, and when it is detected the current in the magnetron reaches the predetermined current value (the predetermined current value indicates that the magnetron starts working), the power signal with the frequency equal to the target frequency is input to the inverter circuit, so that the inverter circuit can be started at a smaller power, and when the magnetron starts working, the inverter circuit operates with full power (i.e., the power signal with the target frequency is input), thereby avoiding the problem of power overshoot during the startup of the inverter circuit.

The control device of the microwave oven circuit according to the above embodiment of the present disclosure can further have the following technical features:

According to one embodiment of the present disclosure, the microwave oven circuit further includes a fan circuit and a turntable circuit, and the control device further includes: a third control device configured to, when an instruction of starting a microwave oven is received, if the current detection device detects that the electric supply signal reaches the zero crossing point, control the fan circuit and the turntable circuit to be turned on; and a determining device configured to, when the third control device controls the fan circuit and the turntable circuit to be turned on for a second predetermined time length, determine that the inverter circuit needs to be started.

According to the control device of the microwave oven circuit of the embodiment of the present disclosure, both a fan and a turntable are inductive loads, so electromagnetic radiation and voltage interference are generated when they are turned on, thus affecting the voltage of the G pole of the IGBT, therefore, when the instruction of starting the microwave oven is received, and when the electric supply signal is detected to reach the zero crossing point, the fan circuit and the turntable circuit are controlled to be turned on, and after delaying the second predetermined time length, the inverter circuit is controlled to be powered on (i.e., it is determined that the inverter circuit needs to be started), in this way, when the fan circuit and the turntable circuit are turned on, the interference to the voltage of the G pole of the IGBT can be effectively reduced so as to prevent the G pole of the IGBT from being damaged by the overlarge voltage and to prolong the service life of the IGBT.

According to one embodiment of the present disclosure, the second control device is further configured to: when an instruction of turning off the microwave oven is received, stop inputting the power signal to the inverter circuit; and the first control device is further configured to: when the time length of stopping inputting the power signal to the inverter circuit by the second control device reaches a third predetermined time length, if the zero crossing point detection device detects that the electric supply signal reaches the zero crossing point, control the inverter circuit to be powered off.

According to the control device of the microwave oven circuit of the embodiment of the present disclosure, when the input of the power signal to the inverter circuit is stopped, the inverter circuit undergoes a process in which the power is reduced to zero and a corresponding discharging process. Therefore, when the instruction of turning off the microwave oven is received, the input of the power signal to the inverter circuit is stopped, and after delaying the third predetermined time length, and when the electric supply signal is detected to reach the zero crossing point, the inverter circuit is controlled to be powered off, in this way, it is ensured that after the power of the inverter circuit is reduced to 0 and when the electric supply signal is at the zero crossing point, the inverter circuit is powered off, thus avoiding an abnormal problem generated by directly controlling the inverter circuit to be powered off when the input of the power signal is stopped.

According to one embodiment of the present disclosure, the third control device is further configured to: after the inverter circuit is controlled by the first control device to be powered off for a fourth predetermined time length, if the electric supply signal is detected to reach the zero crossing point, control the fan circuit and the turntable circuit to be powered off.

According to the control device of the microwave oven circuit of the embodiment of the present disclosure, when the inverter circuit is controlled to be powered off for the fourth predetermined time length, and when the electric supply signal is detected to reach the zero crossing point, the fan circuit and the turntable circuit are controlled to be powered off, therefore the interference to the voltage of the G pole of the IGBT can be reduced, when the inductive loads (i.e., the fan and the turntable) are turned off.

In any one of the above embodiments, the power-on and power-off of the inverter circuit can be controlled by a microwave relay.

According to an embodiment of the present disclosure, a microwave oven is further provided, including the microwave oven circuit in any one of the above embodiments; and/or the control device of the microwave oven circuit in any one of the above embodiments.

### BRIEF DESCRIPTION OF THE DRAWINGS

The present disclosure will become apparent from the following description of embodiments in conjunction with the drawings:

FIG. 1 shows a structural schematic diagram of a control system of a variable frequency microwave oven in related art;

FIG. 2 shows a schematic diagram of a circuit structure of an inverter in a microwave oven circuit in related art;

FIG. 3 shows a schematic diagram of control timing of the inverter in the microwave oven circuit in related art;

FIG. 4 shows a schematic diagram of a voltage waveform of an electric supply signal, a control signal waveform of a microwave relay and a voltage waveform across a rectifier bridge stack when the inverter is started in related art;

FIG. 5 shows a structural schematic diagram of a microwave oven circuit according to an embodiment of the present disclosure;

FIG. 6 shows a structural schematic diagram of an inverter circuit according to an embodiment of the present disclosure;

FIG. 7 shows a structural schematic diagram of a filter circuit in an electric control board according to an embodiment of the present disclosure;

FIG. 8 shows a schematic flow diagram of a control method of a microwave oven circuit according to an embodiment of the present disclosure;

FIG. 9 shows a structural block diagram of a control device of a microwave oven circuit according to an embodiment of the present disclosure;

FIG. 10 shows a schematic diagram of timing of signals in a control process of a microwave oven circuit according to an embodiment of the present disclosure;

FIG. 11 shows a process schematic diagram of starting the inverter as shown in FIG. 10;

FIG. 12 shows a process schematic diagram of turning off the inverter as shown in FIG. 10.

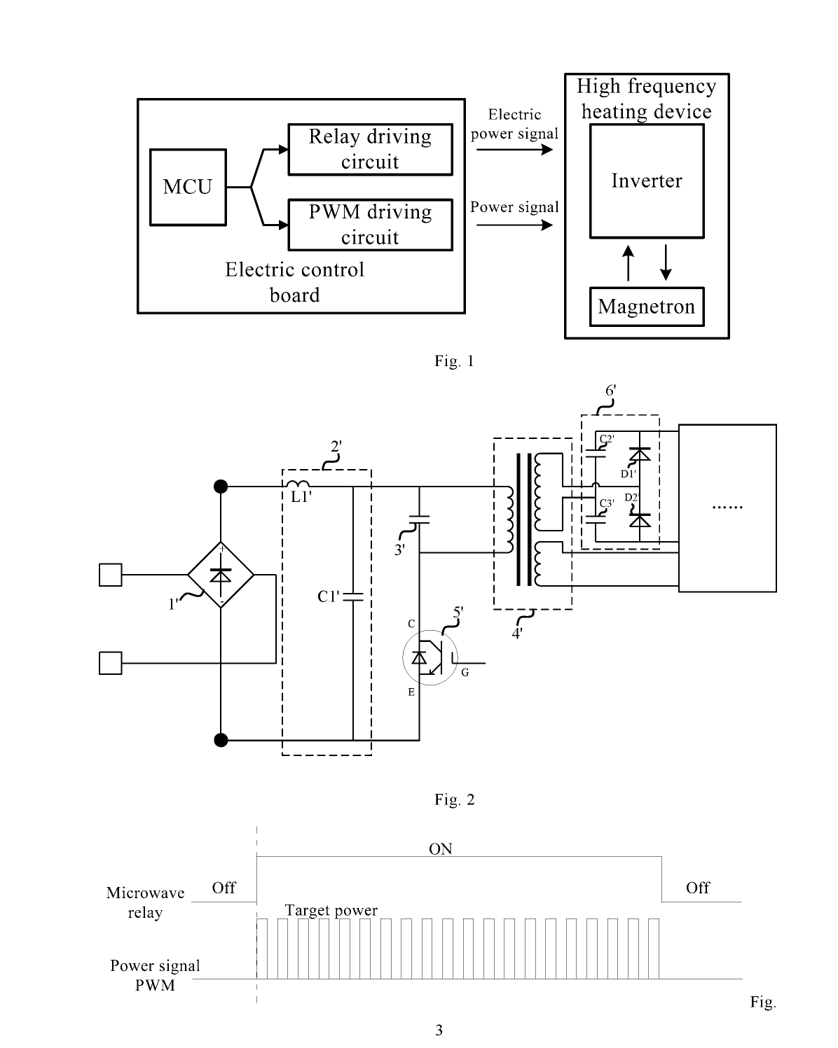

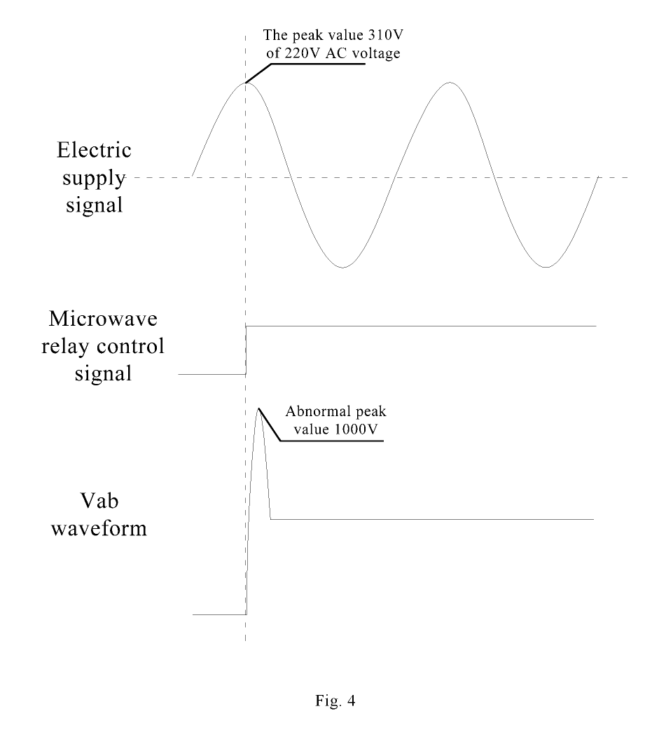

### DETAILED DESCRIPTION OF THE DISCLOSURE

The present disclosure can be understood more clearly, the present disclosure will be further described in detail below in conjunction with the drawings and specific embodiments. It should be noted that the embodiments of the present application and the features in the embodiments can be combined with each other without conflict.

Many specific details are set forth in the following description in order to fully understand the present disclosure. However, the present disclosure can also be implemented in other manners than those described herein. Therefore, the protection scope of the present disclosure is not limited to the specific embodiments disclosed below.

FIG. 5 shows a structural schematic diagram of a microwave oven circuit according to an embodiment of the present disclosure;

As shown in FIG. 5, the microwave oven circuit according to the embodiment of the present disclosure includes an electric control board 1 and a high frequency heating circuit 2; and the electric control board 1 includes:

a relay driving circuit 11 configured to transmit an electric power signal to the high frequency heating circuit 2; a power driving circuit 12 configured to send a power signal to the high frequency heating circuit 2; a first filter circuit 13 connected to a signal feedback end (not shown in FIG. 5) of the high frequency heating circuit 2 and configured to perform filtering processing on a magnetron current signal fed back by the high frequency heating circuit 2; an analog to digital conversion circuit 14 connected to the first filter circuit 13 and configured to perform analog to digital conversion processing on the signal output by the first filter circuit 13; and a controller 15 connected to the analog to digital conversion circuit 14, the relay driving circuit 11 and the power driving circuit 12 and configured to control the electric power signal transmitted by the relay driving circuit 11 and controlling the power signal transmitted by the power driving circuit 12 according to the signal output by the analog to digital conversion circuit 14.

The microwave oven circuit according to the above embodiment of the present disclosure can further have the following technical features:

According to one embodiment of the present disclosure, the high frequency heating circuit 2 includes a magnetron 21 configured to generate microwaves; an inverter circuit 22 connected to the magnetron 21 and configured to receive the electric power signal transmitted by the relay driving circuit 11 and the power signal transmitted by the power driving circuit 12, and driving the magnetron to generate the microwaves according to the electric power signal and the power signal; and a sampling feedback circuit (not shown in FIG. 5) configured to sample the current in the magnetron 21 and feeding back a sampled current signal of the magnetron 21 to the electric control board 1.

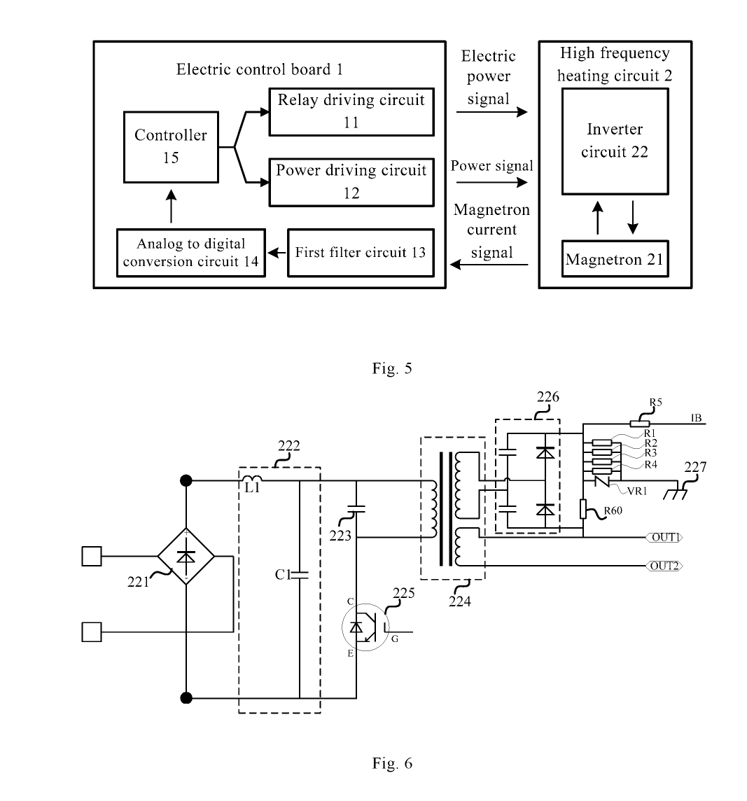

As shown in FIG. 6, the inverter circuit 22 according to one embodiment of the present disclosure includes:

a rectifier circuit 221 connected to an AC power supply and configured to rectify AC input by the AC power supply; a second filter circuit 222 connected to the rectifier circuit 221 and configured to perform filtering processing on a signal output by the rectifier circuit 221; a resonant circuit including a resonant capacitor 223 and a high frequency step-up transformer 224, and the resonant capacitor 223 is connected to two ends of the second filter circuit 222 in parallel after being connected with an IGBT 225 in series, and a primary coil of the high frequency step-up transformer 224 is connected with the resonant capacitor 223 in parallel; and a voltage doubling circuit 226 connected to a secondary coil of the high frequency step-up transformer 224 and configured to generate a voltage for driving the magnetron 21.

The sampling feedback circuit in the high frequency heating circuit 2 includes a current detection loop, and the current detection loop is composed of four resistors R1 to R4 and a varistor VR1, which are connected in parallel, R5 is a current limiting resistor, R60 is a dummy load, a chassis ground 227 is connected to the anode of the magnetron 21, the cathode of the magnetron 21 is connected to OUT1 and OUT2, and OUT1 and OUT2 are connected to the another winding of the secondary coil of the high frequency step-up transformer 224 for driving a filament voltage of the magnetron 21. When the magnetron 21 works, the current flows through the anode, i.e., the chassis ground 227, and flows to the cathode to form a loop, in this way, there is a voltage across R1 to R4, and a current signal D3 in the magnetron is detected by detecting the voltage.

According to one embodiment of the present disclosure, the rectifier circuit 221 includes a rectifier bridge circuit.

According to one embodiment of the present disclosure, the second filter circuit 222 includes an LC filter circuit, namely, an LC filter circuit composed of an inductor L1 and a capacitor C1.

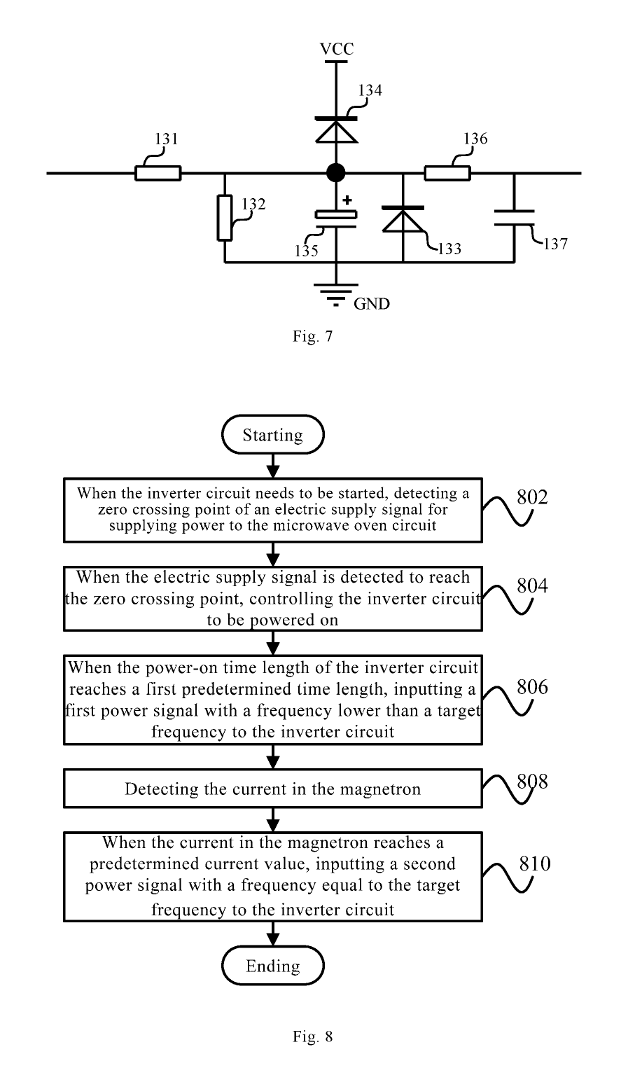

As shown in FIG. 7, according to one embodiment of the present disclosure, the first filter circuit 13 includes: a first resistor 131, and a first end of the first resistor 131 serves as an input end of the first filter circuit 13; a second resistor 132 connected between a second end of the first resistor 131 and the ground; a first clamp device 133 connected with the second resistor 132 in parallel; a second clamp device 134 connected between the second end of the first resistor 131 and a DC power supply; an electrolytic capacitor 135 connected with the second resistor 132 in parallel; a current limiting device 136, and a first end of the current limiting device 136 is connected to the second end of the first resistor 131, and a second end of the current limiting device 136 serves as an output end of the first filter circuit; and a capacitive element 137 connected between the second end of the current limiting device 136 and the ground.

In one embodiment, after the magnetron current signal is input to the first filter circuit 13, the voltage is divided by the first resistor 131 and the second resistor 132 and is clamped by the first clamp device 133 and the second clamp device 134, so that the voltage is not higher than the DC power supply (VCC), nor lower than the GND (ground), and meanwhile, the filtering processing can be performed by the electrolytic capacitor 135 and the capacitive element 137 to convert the high frequency current signal into a low frequency DC signal. By connecting the capacitive element 137 between the second end of the current limiting device 136 and the ground, i.e., connecting the capacitive element to a position close to the output end of the first filter circuit 13, a better filtering effect can be achieved.

According to one embodiment of the present disclosure, the first clamp device 133 includes a first diode, a cathode of the first diode is connected to the second end of the first resistor 131, and an anode of the first diode is grounded.

According to one embodiment of the present disclosure, the second clamp device 134 includes a second diode, an anode of the second diode is connected to the second end of the first resistor 131, and a cathode of the second diode is connected to the DC power supply.

According to one embodiment of the present disclosure, the current limiting device 136 includes a resistive element.

FIG. 8 shows a schematic flow diagram of a control method of a microwave oven circuit according to an embodiment of the present disclosure.

As shown in FIG. 8, the control method of the microwave oven circuit according to the embodiment of the present disclosure includes:

Step 802, when the inverter circuit needs to be started, detecting a zero crossing point of an electric supply signal for supplying power to the microwave oven circuit;

step 804, when the electric supply signal is detected to reach the zero crossing point, controlling the inverter circuit to be powered on;

step 806, when the power-on time length of the inverter circuit reaches a first predetermined time length, inputting a first power signal with a frequency lower than a target frequency to the inverter circuit;

step 808, detecting the current in the magnetron; and

step 810, when the current in the magnetron reaches a predetermined current value, inputting a second power signal with a frequency equal to the target frequency to the inverter circuit.

When the inverter circuit needs to be started, the zero crossing point of the electric supply signal is detected, and when the electric supply signal is detected to reach the zero crossing point, the inverter circuit is controlled to be powered on, therefore when the inverter circuit is powered on, a reverse voltage across a rectifier bridge stack can be effectively reduced, thereby improving the reliability of the microwave oven circuit and prolonging the service life of the rectifier bridge stack.

After the inverter circuit is powered on, the power signal is not directly input to the inverter circuit, but is input after delaying the first predetermined time length, so that power-on initialization time can be reserved for electronic devices in the inverter circuit to ensure the working stability of the inverter circuit.

When the power-on time length of the inverter circuit reaches the first predetermined time length, the first power signal with the frequency lower than the target frequency is input to the inverter circuit, and when it is detected the current in the magnetron reaches the predetermined current value (the predetermined current value indicates that the magnetron starts working), the power signal with the frequency equal to the target frequency is input to the inverter circuit, so that the inverter circuit can be started at a smaller power, and when the magnetron starts working, the inverter circuit operates with full power (i.e., the power signal with the target frequency is input), thereby avoiding the problem of power overshoot during the startup of the inverter circuit.

The control method of the microwave oven circuit according to the above embodiment of the present disclosure can further have the following technical features:

According to one embodiment of the present disclosure, the microwave oven circuit further includes a fan circuit and a turntable circuit, and the control method further includes:

when an instruction of starting a microwave oven is received, if the electric supply signal is detected to reach the zero crossing point, controlling the fan circuit and the turntable circuit to be turned on; and when the fan circuit and the turntable circuit are controlled to be turned on for a second predetermined time length, determining that the inverter circuit needs to be started.

Both a fan and a turntable are inductive loads, so electromagnetic radiation and voltage interference are generated when they are turned on, thus affecting the voltage of the G pole of the IGBT, therefore, when the instruction of starting the microwave oven is received, and when the electric supply signal is detected to reach the zero crossing point, the fan circuit and the turntable circuit are controlled to be turned on, and after delaying the second predetermined time length, the inverter circuit is controlled to be powered on (i.e., it is determined that the inverter circuit needs to be started), in this way, when the fan circuit and the turntable circuit are turned on, the interference to the voltage of the G pole of the IGBT can be effectively reduced so as to prevent the G pole of the IGBT from being damaged by the overlarge voltage and to prolong the service life of the IGBT.

According to one embodiment of the present disclosure, the control method further includes: when an instruction of turning off the microwave oven is received, stopping inputting the power signal to the inverter circuit; and when the time length of stopping inputting the power signal to the inverter circuit reaches a third predetermined time length, if the electric supply signal is detected to reach the zero crossing point, controlling the inverter circuit to be powered off.

When the input of the power signal to the inverter circuit is stopped, the inverter circuit undergoes a process in which the power is reduced to zero and a corresponding discharging process. Therefore, when the instruction of turning off the microwave oven is received, the input of the power signal to the inverter circuit is stopped, and after delaying the third predetermined time length, and when the electric supply signal is detected to reach the zero crossing point, the inverter circuit is controlled to be powered off, in this way, it is ensured that after the power of the inverter circuit is reduced to 0 and when the electric supply signal is at the zero crossing point, the inverter circuit is powered off, thus avoiding an abnormal problem generated by directly controlling the inverter circuit to be powered off when the input of the power signal is stopped.

According to one embodiment of the present disclosure, the control method further includes: after the inverter circuit is controlled to be powered off for a fourth predetermined time length, if the electric supply signal is detected to reach the zero crossing point, controlling the fan circuit and the turntable circuit to be powered off.

When the inverter circuit is controlled to be powered off for the fourth predetermined time length, and when the electric supply signal is detected to reach the zero crossing point, the fan circuit and the turntable circuit are controlled to be powered off, therefore the interference to the voltage of the G pole of the IGBT can be reduced, when the inductive loads (i.e., the fan and the turntable) are turned off.

According to one embodiment of the present disclosure, the first predetermined time length is greater than or equal to 300 milliseconds; the second predetermined time length is greater than or equal to 200 milliseconds; the third predetermined time length is greater than or equal to 200 milliseconds; and the fourth predetermined time length is greater than or equal to 600 milliseconds.

According to one embodiment of the present disclosure, the frequency of the first power signal is the lowest frequency for maintaining the continuous work of the inverter circuit, or

the frequency of the first power signal is less than or equal to half of the lowest frequency for maintaining the continuous work of the inverter circuit.

According to one embodiment of the present disclosure, the predetermined current value is less than or equal to one-sixth of the current value in the magnetron when the inverter circuit works at the input of the target frequency.

In any one of the above embodiments, the power-on and power-off of the inverter circuit can be controlled by a microwave relay.

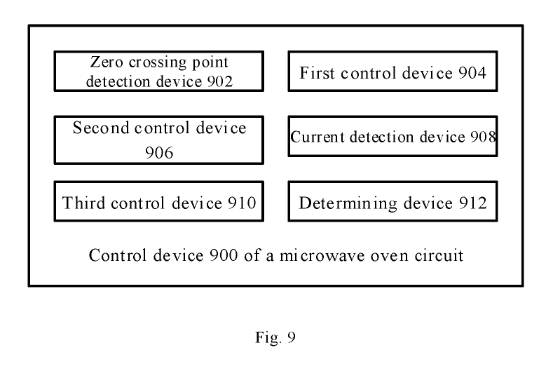

FIG. 9 shows a structural block diagram of a control device of a microwave oven circuit according to an embodiment of the present disclosure.

As shown in FIG. 9, the control device 900 of the microwave oven circuit according to the embodiment of the present disclosure includes: a zero crossing point detection device 902, a first control device 904, a second control device 906 and a current detection device 908.

The zero crossing point detection device 902 is configured to, when the inverter circuit needs to be started, detect a zero crossing point of an electric supply signal for supplying power to the microwave oven circuit; the first control device 904 is configured to, when the zero crossing point detection device 902 detects that the electric supply signal reaches the zero crossing point, control the inverter circuit to be powered on; the second control device 906 is configured to, when the power-on time length of the inverter circuit reaches a first predetermined time length, input a first power signal with a frequency lower than a target frequency to the inverter circuit, and when the current detection device 908 detects that the current in the magnetron reaches a predetermined current value, inputting a second power signal with a frequency equal to the target frequency to the inverter circuit. The current detection device 908 is configured to detect the current in the magnetron.

When the inverter circuit needs to be started, the zero crossing point of the electric supply signal is detected, and when the electric supply signal is detected to reach the zero crossing point, the inverter circuit is controlled to be powered on, therefore when the inverter circuit is powered on, a reverse voltage across a rectifier bridge stack can be effectively reduced, thereby improving the reliability of the microwave oven circuit and prolonging the service life of the rectifier bridge stack.

After the inverter circuit is powered on, the power signal is not directly input to the inverter circuit, but is input after delaying the first predetermined time length, so that power-on initialization time can be reserved for electronic devices in the inverter circuit to ensure the working stability of the inverter circuit.

When the power-on time length of the inverter circuit reaches the first predetermined time length, the first power signal with the frequency lower than the target frequency is input to the inverter circuit, and when it is detected the current in the magnetron reaches the predetermined current value (the predetermined current value indicates that the magnetron starts working), the power signal with the frequency equal to the target frequency is input to the inverter circuit, so that the inverter circuit can be started at a smaller power, and when the magnetron starts working, the inverter circuit operates with full power (i.e., the power signal with a frequency equal to the target frequency is input), thereby avoiding the problem of power overshoot during the startup of the inverter circuit.

The control device 900 of the microwave oven circuit according to the above embodiment of the present disclosure can further have the following technical features:

According to one embodiment of the present disclosure, the microwave oven circuit further includes a fan circuit and a turntable circuit, and the control device 900 further includes: a third control device 910 configured to, when an instruction of starting a microwave oven is received, if the current detection device 908 detects that the electric supply signal reaches the zero crossing point, control the fan circuit and the turntable circuit to be turned on; and a determining device 912 configured to, when the third control device 910 controls the fan circuit and the turntable circuit to be turned on for a second predetermined time length, determine that the inverter circuit needs to be started.

Both a fan and a turntable are inductive loads, so electromagnetic radiation and voltage interference are generated when they are turned on, thus affecting the voltage of the G pole of the IGBT, therefore, when the instruction of starting the microwave oven is received, and when the electric supply signal is detected to reach the zero crossing point, the fan circuit and the turntable circuit are controlled to be turned on, after delaying the second predetermined time length, the inverter circuit is controlled to be powered on (i.e., it is determined that the inverter circuit needs to be started), in this way, when the fan circuit and the turntable circuit are turned on, the interference to the voltage of the G pole of the IGBT can be effectively reduced so as to prevent the G pole of the IGBT from being damaged by the overlarge voltage and to prolong the service life of the IGBT.

According to one embodiment of the present disclosure, the second control device 906 is further configured to: when an instruction of turning off the microwave oven is received, stop inputting the power signal to the inverter circuit; and the first control device 904 is further configured to: when the time length of stopping inputting the power signal to the inverter circuit by the second control device 906 reaches a third predetermined time length, if the zero crossing point detection device 902 detects that the electric supply signal reaches the zero crossing point, control the inverter circuit to be powered off.

When the input of the power signal to the inverter circuit is stopped, the inverter circuit undergoes a process in which the power is reduced to zero and a corresponding discharging process. Therefore, when the instruction of turning off the microwave oven is received, the input of the power signal to the inverter circuit is stopped, and after delaying the third predetermined time length, and when the electric supply signal is detected to reach the zero crossing point, the inverter circuit is controlled to be powered off, in this way, it is ensured that after the power of the inverter circuit is reduced to 0 and when the electric supply signal is at the zero crossing point, the inverter circuit is powered off, thus avoiding an abnormal problem generated by directly controlling the inverter circuit to be powered off when the input of the power signal is stopped.

According to one embodiment of the present disclosure, the third control device 910 is further configured to: after the inverter circuit is controlled by the first control device 904 to be powered off for a fourth predetermined time length, if the electric supply signal is detected to reach the zero crossing point, controlling the fan circuit and the turntable circuit to be powered off.

When the inverter circuit is controlled to be powered off for the fourth predetermined time length, if the electric supply signal is detected to reach the zero crossing point, the fan circuit and the turntable circuit are controlled to be powered off, therefore the interference to the voltage of the G pole of the IGBT can be reduced, when the inductive loads (i.e., the fan and the turntable) are turned off.

In any one of the above embodiments, the power-on and power-off of the inverter circuit can be controlled by a microwave relay.

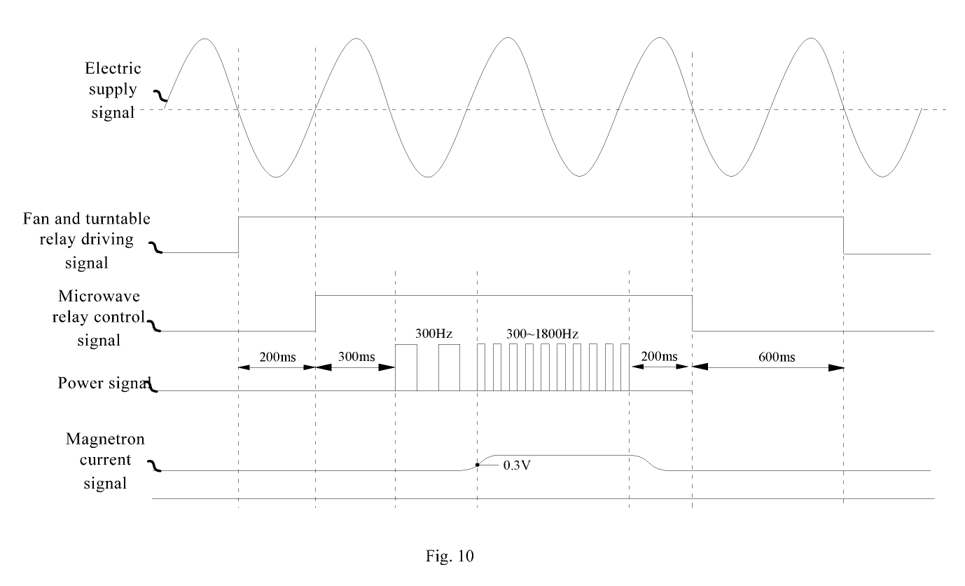

The overall control solution of the present disclosure will be described below with reference to FIG. 10.

FIG. 10 shows a schematic diagram of timing of signals in a control process of a microwave oven circuit according to an embodiment of the present disclosure.

The control solution in the related art is as follows: when the microwave relay (i.e., power is supplied to the inverter) of the microwave oven is started, the fan and the turntable relay are also turned on at the same time. Because the fan and the turntable are both inductive loads, electromagnetic radiation and voltage interference are generated during turn-on, meanwhile due to the complicated electric connecting lines of the microwave oven, it is impossible to focus on a specific line, and the radiation is also difficult to measure. Thus, in order to reduce the voltage abnormality (i.e., abnormal rise) of the G pole of the IGBT, in the embodiment, the interference of the fan and the turntable is minimized, and the specific process is as follows:

As shown in FIG. 10, when the instruction of starting the microwave oven is received, fan and turntable relays are started at the zero crossing point of the electric supply signal to delay for a period of time, for example, more than 200 ms after the fan and the turntable are turned on, and then when the electric supply signal reaches the zero crossing point, the microwave relay is started to supply power to the inverter so as to reduce the interference signal to the voltage of the G pole of the IGBT generated by the simultaneous starting of the fan and turntable relays and the microwave relay. Moreover, when the electric supply signal reaches the zero crossing point, the microwave relay is started to avoid the damage to the entire rectifier bridge stack by the reverse high voltage generated to the rectifier bridge stack at the moment of starting the microwave relay. The starting process of the microwave relay is a power-on process of the inverter.

When the microwave relay is turned on, namely, when the electric power signal is provided for the inverter, the power signal is not immediately provided for the inverter, but a period of time is delayed, for example, more than 300 ms to reserve an enough power-on initialization time for the devices in the inverter circuit to ensure no random action of the inverter. The stage is called an initialization stage.

Then, after the initialization stage, a preheating stage is executed to provide preheating frequency of 300 Hz for the inverter. After the inverter receives the preheating frequency, the inverter is started at a smaller power to avoid the problem of power overshoot in the startup process. The preheating frequency can be the lowest frequency for maintaining the continuous work of the inverter, or any value less than or equal to half of the lowest frequency for maintaining the continuous work of the inverter.

At the preheating stage, the current signal of the magnetron is detected, an AD value is obtained by filtering and analog to digital conversion processing, and if the AD value is greater than a predetermined value, a full-power operation stage is entered.

Generally, the predetermined value is relatively small and is related to the value of the device shown in FIG. 7. In one embodiment of the present disclosure, if the first resistor 131 is 10K, the second resistor 132 is 1M, and the electrolytic capacitor 135 is 2.2 uF, at this time, the predetermined value can be selected as 0.3V, and 0.3V represents a symbol indicating that the magnetron starts working; however, the predetermined value may be too large, such as 0.5V or more, because at a low temperature, the current of the magnetron at the initial working stage is smaller than that at a room temperature, which will lead to always staying at the preheating stage.

In one embodiment of the present disclosure, the predetermined value compared with the AD value can be selected from any value less than or equal to one-sixth of the current signal in the magnetron when the electric control boards inputs a power signal with the target frequency to the inverter.

Finally, at the full-power operation stage, the electric control board inputs a power signal with the target frequency to the inverter.

For example, the electric control board needs to output a power of 1500 W to the inverter, the electric control board outputs the preheating frequency of 300 Hz at the preheating stage and outputs the frequency of 1500 Hz when the AD value is greater than 0.3V, and in this way, the power overshoot problem in the startup process can be reduced.

When the inverter is running operating at full power, if the inverter is required to stop working, the input of the power signal to the inverter may be stopped at first, and after delaying for a period of time, such as more than 200 ms, the microwave relay is turned off; because when the electric control board stops inputting the power signal to the inverter, the inverter needs to undergoes a process in which the power is reduced to zero and a corresponding discharging process, if the microwave relay is turned off quickly, the turning off process is incomplete, resulting in an abnormal phenomenon. Meanwhile, it should be noted that the microwave relay is turned off when the electric supply signal reaches the zero crossing point.

In addition, after the microwave relay is turned off, after a period of time, when the electric supply signal reaches the zero crossing point, the fan and the turntable relays are turned off, for example, the fan and the turntable relays are turned off 600 ms later, which can also reduce the influence on the voltage of the G pole of the IGBT when the inductive loads are turned off.

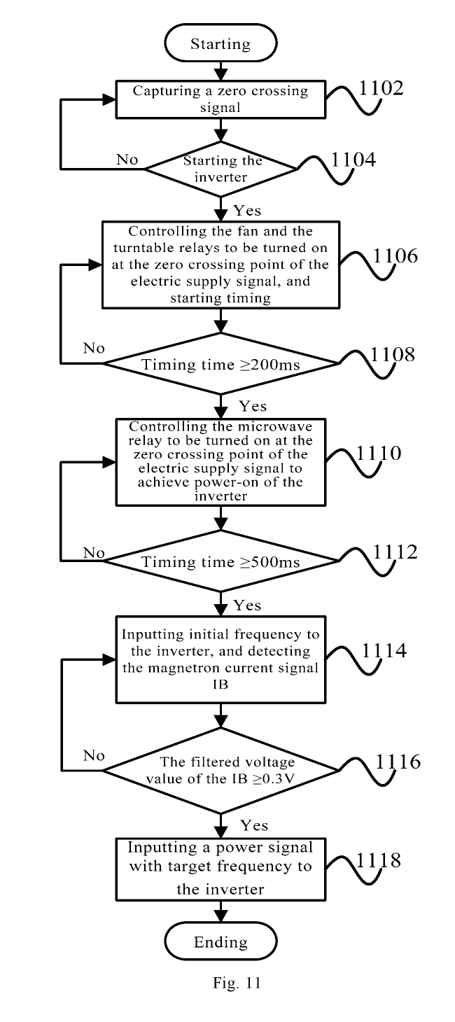

The process of starting the inverter shown in FIG. 10 is as shown in FIG. 11, including:

Step 1102, capturing a zero crossing signal of electric supply;

step 1104, judging whether the inverter is started, and if so, executing step 1106;

otherwise, returning to step 1102;

step 1106, controlling the fan and the turntable relays to be turned on at the zero crossing point of the electric supply signal, and starting timing

step 1108, judging whether the timing time is greater than or equal to 200 ms, and if so, executing step 1110; otherwise, returning to step 1106;

step 1110, controlling the microwave relay to be turned on when the electric supply signal reaches the zero crossing point to achieve power-on of the inverter;

step 1112, judging whether the timing time is greater than or equal to 500 ms, and if so, executing step 1114; otherwise, returning to step 1110;

step 1114, inputting an initial power to the inverter, and detecting a current signal IB in the magnetron;

step 1116, judging whether a filtered voltage value of the D3 is greater than or equal to 0.3V, and if so, executing step 1118; otherwise, returning to step 1114; and

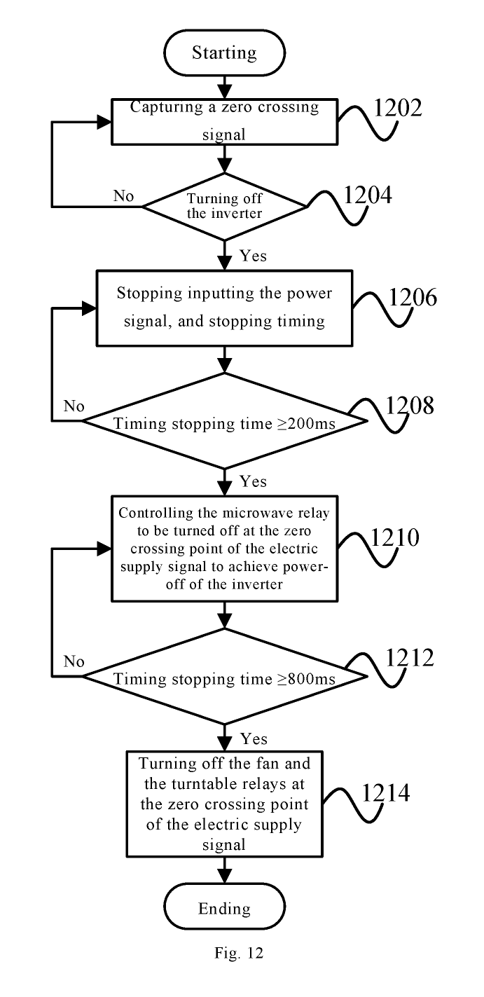

step 1118, inputting the power signal with the target frequency to the inverter. The process of turning off the inverter as shown in FIG. 10 is as shown in FIG. 12, including:

Step 1202, capturing a zero crossing signal of electric supply;

step 1204, judging whether the inverter is turned off, and if so, executing step 1206;

otherwise, returning to step 1202;

step 1206, stopping inputting the power signal to the inverter, and stopping timing;

step 1208, judging whether the timing stopping time is greater than or equal to 200 ms, and if so, executing step 1210; otherwise, returning to step 1206;

step 1210, controlling the microwave relay to be turned off when the electric supply signal reaches the zero crossing point to achieve power-off of the inverter;

step 1212, judging whether the timing stopping time is greater than or equal to 800 ms, and if so, executing step 1214; otherwise, returning to step 1210; and

step 1214, turning off the fan and turntable relays at the zero crossing point of the electric supply signal.

In one embodiment of the present disclosure, since the microwave oven sold in Japan has a mandatory authentication requirement that the input current cannot exceed 15 A, in order to meet the corresponding requirements, the control mode of the inverter in the microwave oven sold in Japan is distinguished from other conventional control modes, different preheating frequency modes are adopted, when the preheating frequency in the conventional control mode is 300 Hz, the preheating frequency in the control mode of the inverter in the microwave oven sold in Japan is 100 Hz.

In the technical solution of the above embodiment of the present disclosure, the current in the magnetron is used as the key signal for starting the inverter by the electric control board, and relatively reasonable design is performed on the starting and turning off of the inverter; meanwhile, the starting timing of other loads in the starting and turning off processes of the inverter is regulated accordingly to reduce the interference voltage of the G pole of the IGBT; and in addition, the electric power of the inverter is conveyed at the zero crossing point of the electric supply voltage, thereby reducing the reverse voltage across the rectifier bridge stack, improving the reliability and prolonging the service life of the rectifier circuit.

The technical solution of the present disclosure has been described in detail above with reference to the drawings. The present disclosure proposes a new microwave oven circuit control solution, which can reduce the voltage across the rectifier bridge stack when the inverter is started so as to avoid damage to the rectifier bridge stack due to the excessively high voltage across the rectifier bridge stack and to prevent the G pole of the IGBT from being damaged by the overlarge voltage.

1. A microwave oven circuit, comprising:
an electric control board and a high frequency heating circuit, wherein the electric control board comprises:
a relay driving circuit configured to transmit an electric power signal to the high frequency heating circuit;
a power driving circuit configured to send a power signal to the high frequency heating circuit;
a first filter circuit connected to a signal feedback end of the high frequency heating circuit and configured to perform filtering processing on a magnetron current signal fed back by the high frequency heating circuit;
an analog to digital conversion circuit connected to the first filter circuit and used for performing analog to digital conversion processing on the signal output by the first filter circuit; and
a controller connected to the analog to digital conversion circuit, the relay driving circuit and the power driving circuit and used for controlling the electric power signal transmitted by the relay driving circuit and controlling the power signal transmitted by the power driving circuit according to the signal output by the analog to digital conversion circuit.

2. The microwave oven circuit according to claim 1, wherein the high frequency heating circuit comprises:
a magnetron used for generating microwaves;
an inverter circuit connected to the magnetron and configured to receive the electric power signal transmitted by the relay driving circuit and the power signal transmitted by the power driving circuit, and driving the magnetron to generate the microwaves according to the electric power signal and the power signal; and
a sampling feedback circuit configured to sample the current in the magnetron and feeding back a sampled magnetron current signal to the electric control board.

3. The microwave oven circuit according to claim 2, wherein the inverter circuit comprises:
a rectifier circuit connected to an AC power supply and configured to rectify AC input by the AC power supply;
a second filter circuit connected to the rectifier circuit and configured to perform filtering processing on a signal output by the rectifier circuit;
a resonant circuit comprising a resonant capacitor and a high frequency step-up transformer, wherein the resonant capacitor is connected to two ends of the second filter circuit in parallel after being connected with an IGBT in series, and a primary coil of the high frequency step-up transformer is connected with the resonant capacitor in parallel; and
a voltage doubling circuit connected to a secondary coil of the high frequency step-up transformer and configured to generate a voltage for driving the magnetron.

4. The microwave oven circuit according to claim 3, wherein the rectifier circuit comprises a rectifier bridge circuit.

5. The microwave oven circuit according to claim 3, wherein the second filter circuit comprises an LC filter circuit.

6. The microwave oven circuit according to claim 1, wherein the first filter circuit comprises:
a first resistor, wherein a first end of the first resistor serves as an input end of the first filter circuit;
a second resistor connected between a second end of the first resistor and the ground;
a first clamp device connected with the second resistor in parallel;
a second clamp device connected between the second end of the first resistor and a DC power supply;
an electrolytic capacitor connected with the second resistor in parallel;
a current limiting device, wherein a first end of the current limiting device is connected to the second end of the first resistor, and the second end of the current limiting device serves as an output end of the first filter circuit; and
a capacitive element connected between the second end of the current limiting device and the ground.

7. The microwave oven circuit according to claim 6, wherein the first clamp device comprises a first diode, a cathode of the first diode is connected to the second end of the first resistor, and an anode of the first diode is grounded.

8. The microwave oven circuit according to claim 6, wherein the second clamp device comprises a second diode, an anode of the second diode is connected to the second end of the first resistor, and a cathode of the second diode is connected to the DC power supply.

9. The microwave oven circuit according to claim 6, wherein the current limiting device comprises a resistive element.

10. A control method of a microwave oven circuit, wherein the microwave oven circuit comprises a magnetron and an inverter circuit for driving the magnetron to work, and the control method comprises:
when the inverter circuit needs to be started, detecting a zero crossing point of an electric supply signal for supplying power to the microwave oven circuit;
when the electric supply signal is detected to reach the zero crossing point, controlling the inverter circuit to be powered on;
when the power-on time length of the inverter circuit reaches a first predetermined time length, inputting a first power signal with a frequency lower than a target frequency to the inverter circuit;
detecting the current in the magnetron; and
when the current in the magnetron reaches a predetermined current value, inputting a second power signal with a frequency equal to the target frequency to the inverter circuit.

11. The control method of the microwave oven circuit according to claim 10, wherein the microwave oven circuit further comprises a fan circuit and a turntable circuit, and the control method further comprises:
when an instruction of starting a microwave oven is received, if the electric supply signal is detected to reach the zero crossing point, controlling the fan circuit and the turntable circuit to be turned on; and
when the fan circuit and the turntable circuit are controlled to be turned on for a second predetermined time length, determining that the inverter circuit needs to be started.

12. The control method of the microwave oven circuit according to claim 11, further comprising:
when an instruction of turning off the microwave oven is received, stopping inputting the power signal to the inverter circuit; and
when the time length of stopping inputting the power signal to the inverter circuit reaches a third predetermined time length, if the electric supply signal is detected to reach the zero crossing point, controlling the inverter circuit to be powered off.

13. The control method of the microwave oven circuit according to claim 12, further comprising:
after the inverter circuit is controlled to be powered off for a fourth predetermined time length, if the electric supply signal is detected to reach the zero crossing point, controlling the fan circuit and the turntable circuit to be powered off.

14. The control method of the microwave oven circuit according to claim 13, wherein:
the first predetermined time length is greater than or equal to 300 milliseconds;
the second predetermined time length is greater than or equal to 200 milliseconds;
the third predetermined time length is greater than or equal to 200 milliseconds; and
the fourth predetermined time length is greater than or equal to 600 milliseconds.

15. The control method of the microwave oven circuit according to claim 10, wherein:
the frequency of the first power signal is the lowest frequency for maintaining the continuous work of the inverter circuit, or
the frequency of the first power signal is less than or equal to half of the lowest frequency for maintaining the continuous work of the inverter circuit.

16. The control method of the microwave oven circuit according to claim 10, wherein the predetermined current value is less than or equal to one-sixth of the current value in the magnetron when the inverter circuit works at the input of the target frequency.

17. A control device of a microwave oven circuit, wherein the microwave oven circuit comprises a magnetron and an inverter circuit for driving the magnetron to work, and the control device comprises:
a zero crossing point detection device configured to, when the inverter circuit needs to be started, detect a zero crossing point of an electric supply signal for supplying power to the microwave oven circuit;
a first control device configured to, when the zero crossing point detection device detects that the electric supply signal reaches the zero crossing point, control the inverter circuit to be powered on;
a second control device configured to, when the power-on time length of the inverter circuit reaches a first predetermined time length, input a first power signal with a frequency lower than a target frequency to the inverter circuit, and
when a current detection device detects that the current in the magnetron reaches a predetermined current value, inputting a second power signal with a frequency equal to the target frequency to the inverter circuit; and
the current detection device configured to detect the current in the magnetron.

18. The control device of the microwave oven circuit according to claim 17, wherein the microwave oven circuit further comprises a fan circuit and a turntable circuit, and the control device further comprises:
a third control device configured to, when an instruction of starting a microwave oven is received, if the current detection device detects that the electric supply signal reaches the zero crossing point, control the fan circuit and the turntable circuit to be turned on; and
a determining device configured to, when the third control device controls the fan circuit and the turntable circuit to be turned on for a second predetermined time length, determine that the inverter circuit needs to be started.

19. The control device of the microwave oven circuit according to claim 18, wherein:
the second control device is further configured to: when an instruction of turning off the microwave oven is received, stop inputting the power signal to the inverter circuit; and
the first control device is further configured to: when the time length of stopping inputting the power signal to the inverter circuit by the second control device reaches a third predetermined time length, if the zero crossing point detection device detects that the electric supply signal reaches the zero crossing point, control the inverter circuit to be powered off.

20. The control device of the microwave oven circuit according to claim 19, wherein the third control device is further configured to:
after the inverter circuit is controlled by the first control device to be powered off for a fourth predetermined time length, if the electric supply signal is detected to reach the zero crossing point, control the fan circuit and the turntable circuit to be powered off.
